(19) United States
(12) Patent Application Publication
(10) Pub. No.: US 2017/0059880 A1
(43) Pub. Date: Mar. 2, 2017

(54) ACTUATOR AND LENS BARREL USING SAME

(71) Applicant: Panasonic Intellectual Property Management Co., Ltd., Osaka (JP)

(72) Inventor: Hiroyasu FUJINAKA, Osaka (JP)

(21) Appl. No.: 15/228,145

(22) Filed: Aug. 4, 2016

(30) Foreign Application Priority Data
Aug. 25, 2015 (JP) 2015-165329
Jun. 15, 2016 (JP) 2016-118896

(51) Int. Cl. G02B 27/64; H02N 2/00; G02B 7/02

(52) U.S. Cl. CPC G02B 27/646; G02B 7/023; H02N 2/0095

(57) ABSTRACT

The actuator has a y-drive magnet and a y-yoke, and an attractive force occurs between the y-drive magnet and the y-yoke. The y-yoke is movable relative to the y-drive magnet in a plane perpendicular to a direction of magnetization of the y-drive magnet. The y-yoke has a flat section and a protrusion that protrudes from the flat section toward the y-drive magnet. The protrusion is disposed in the middle part of the flat section.

### BACKGROUND

1. Field of the Invention

The present disclosure relates to an electromagnetically-driven actuator and a lens barrel using the same.

2. Description of the Related Art

A reciprocating linear actuator is disclosed in Japanese Unexamined Patent Application Publication No. 2007-37273. The reciprocating linear actuator has a stator having a winding and a moving element having permanent magnets. The moving element opposes the stator via a gap and is held reciprocable to the stator. The magnetic poles of the permanent magnets on the opposite side to the stator are magnetically connected through a yoke. The yoke of the moving element has protrusions that protrude toward the stator. They are disposed at the both ends of the yoke in the reciprocating direction and between opposite poles of the permanent magnet lined in the reciprocating direction. The structure above allows the actuator to have improvement in thrust by decrease in magnetic reluctance and to be kept compact in size.

### SUMMARY

The present disclosure provides an actuator effective in downsizing a lens barrel and a lens barrel.

The actuator of the present disclosure has a magnet and a yoke. An attractive force is generated between the yoke and the magnet. At least any one of the magnet and the yoke is movable relative to the other in a plane perpendicular to a direction of magnetization of the magnet. The yoke has a flat section and a protrusion that protrudes from the flat section toward the magnet. The protrusion is disposed in the middle part of the flat section.

The lens barrel of the present disclosure has an image blur correction unit. The image blur correction unit has a base member, a movable member, a magnet, and a yoke. A lens is fixed to the movable member. An attractive force is generated between the yoke and the magnet. At least any one of the magnet and the yoke is movable relative to the other in a plane perpendicular to a direction of magnetization of the magnet. The yoke has a flat section and a protrusion that protrudes from the flat section toward the magnet. The protrusion is disposed in the middle part of the flat section. Any one of the magnet and the yoke is disposed on the movable member, and the other is disposed on the base member.

### BRIEF DESCRIPTION OF DRAWINGS

FIG. 1A is a perspective view of a lens barrel in a housed state in accordance with a first exemplary embodiment;

FIG. 1B a perspective view of a lens barrel in a shooting state in accordance with the first exemplary embodiment;

FIG. 2 is an exploded perspective view of the lens barrel in accordance with the first exemplary embodiment;

FIG. 3 is an exploded perspective view of a third-group unit in accordance with the first exemplary embodiment;

FIG. 4A shows the structure of an actuator in accordance with the first exemplary embodiment;

FIG. 4B shows the structure of the actuator in accordance with the first exemplary embodiment;

FIG. 4C shows the structure of the actuator in accordance with the first exemplary embodiment;

FIG. 4D shows the structure of the actuator in accordance with the first exemplary embodiment;

FIG. 5A illustrates a relation between the magnet and the yoke of the actuator of the exemplary embodiment;

FIG. 5B illustrates a relation between the magnet and the yoke of an actuator of a comparative example; FIG. 6 illustrates a relation between a movement amount and cogging force in accordance with the first exemplary embodiment;

FIG. 7 illustrates a relation between a movement amount and thrust attractive force in accordance with the first exemplary embodiment;

FIG. 8 illustrates a reduction principle of cogging force in accordance with the first exemplary embodiment;

FIG. 9 illustrates reduction principle of the amount of change in thrust attractive force in accordance with the first exemplary embodiment;

FIG. 10A shows an example of a yoke formed by bending a plate material;

FIG. 10B shows an example of a yoke formed of two members screwed with each other;

FIG. 10C shows an example of a yoke formed of stacked flat members.

### DETAILED DESCRIPTION

Hereinafter, an exemplary embodiment will be described in detail, with reference to the accompanying drawings. However, details beyond necessity (for example, descriptions on well-known matters or on substantially identical structures) may be omitted to eliminate redundancy from the description below for easy understanding of those skilled in the art.

It is to be understood that the accompanying drawings and the description below are for purposes of full understanding of those skilled in the art and are not to be construed as limitation on the scope of the claimed disclosure.

### First Exemplary Embodiment

Hereinafter, the structure of the first exemplary embodiment will be described with reference to accompanying drawings.

### [1. Structure of Lens Barrel]

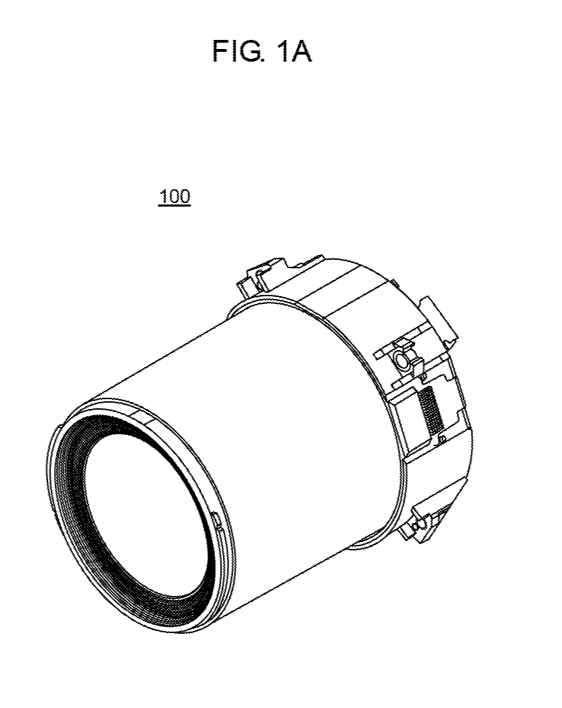

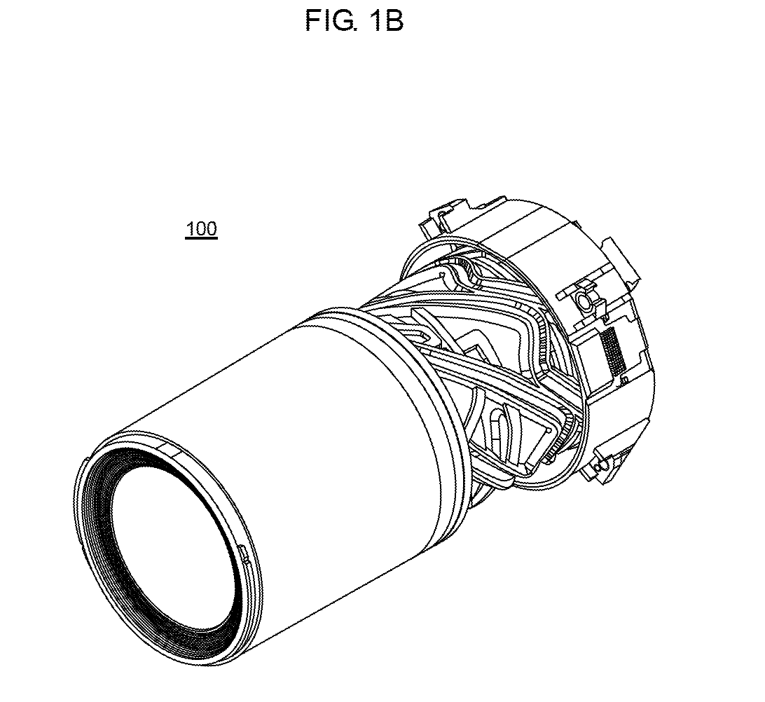

FIG. 1A and FIG. 1B are perspective views of lens barrel 100 of the embodiment. FIG. 1A shows lens barrel 100 in a housed state, whereas FIG. 1B shows it in a shooting state.

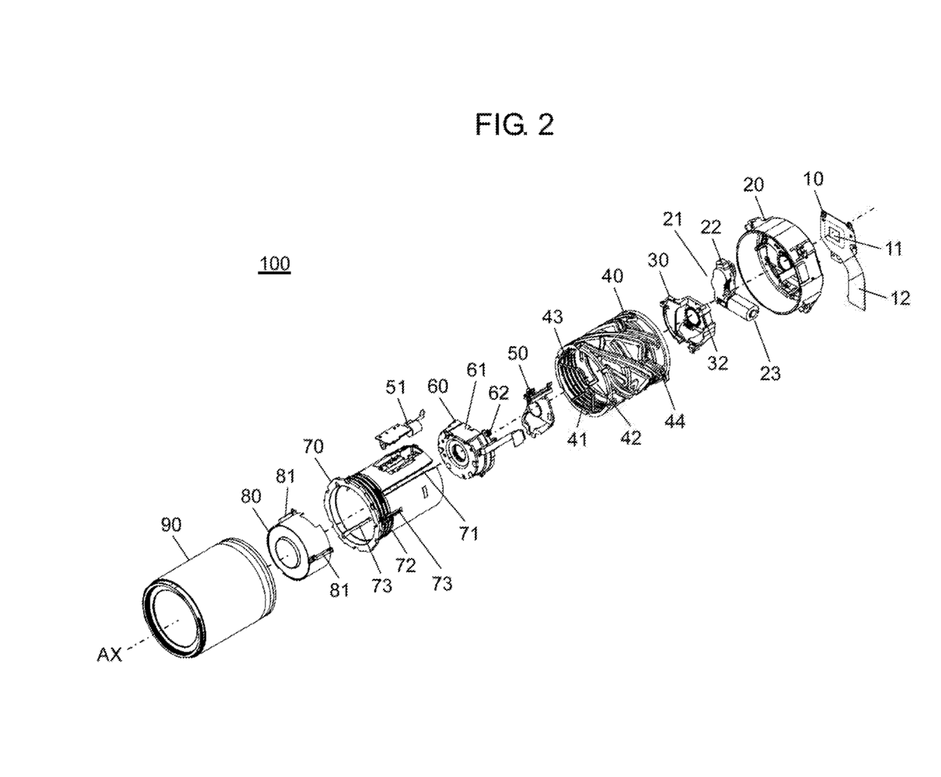

FIG. 2 is an exploded perspective view of lens barrel 100 of the embodiment. An optical system, which forms image onto imaging element 11, is held by lens barrel 100 so as to have zooming in/out operation. In the description of the embodiment, for the sake of convenience, under the state where lens barrel 100 is attached to the camera body, the object side in a direction parallel to optical axis AX of lens barrel 100 (i.e., in an optical-axis direction) is referred to ‘front’ or ‘positive in the z-axis direction’, and the camera-body side in the optical-axis direction is referred to ‘back’ or ‘negative in the z-axis direction’. The right side seen from the object in the optical-axis direction is referred to as ‘right’ or ‘positive in the x-axis direction’, and the left side seen from the object in the optical-axis direction is referred to as ‘left’ or ‘negative in the x-axis direction’. Further, the up side seen from the object in the optical-axis direction is referred to as ‘up’ or ‘positive in the y-axis direction’, and the under side seen from the object in the optical-axis direction is referred to as ‘down’ or ‘negative in the y-axis direction’.

Besides, as long as there is no particular description, the direction in parallel to optical axis AX is referred to as the optical-axis direction, the direction perpendicular to the optical-axis direction is referred to as the radial direction, and the direction along the circle having optical axis AX as the center is referred to as the circumferential direction. Optical axis AX substantially coincides with the center of axis of each frame forming lens barrel 100.

Similarly, as long as there is no particular description, “moving forward” means the movement in the optical-axis direction without rotation in the circumferential direction; “moving” includes, as the conceptual meaning, movement in the optical-axis direction while rotating in the circumferential direction.

Lens barrel 100 shown in FIG. 2 has imaging-element unit 10, master flange 20, fifth-group unit 30, cam frame 40, fourth-group unit 50, third-group unit 60, middle frame 70, second-group unit 80, and first-group unit 90.

Imaging-element unit 10 has imaging element 11 and flexible printed board 12. Imaging element 11 converts an image formed by the optical system having a plurality of optical elements into an electric signal. Flexible printed board 12 connects imaging element 11 to main unit circuitry.

Master flange 20 is a substantially cylindrical member to be fixed to the camera body. Imaging element 10 is attached to the back end on the back side of master flange 20. Master flange 20 retains cam frame 40, zoom motor unit 21. Zoom motor unit 21 has drive gear 22 and zoom motor 23 that rotatably drives drive gear 22. Zoom motor unit 21 is fixed on the front side of the back end of master flange 20. Cam frame 40 is held by master flange 20 so as not to be movable in the optical-axis direction but to be rotatable on the optical axis.

Fifth-group unit 30 retains a lens that changes magnification. Fifth-group unit 30 has fifth-group cam follower 32 protruding in the radial direction. Fifth-group cam follower 32 is inserted into third-group/fifth-group rectilinear groove 71 of middle frame 70 and engaged with a fifth-group cam groove (not shown) of the inner periphery of cam frame 40. Rotation of cam frame 40 allows fifth-group cam follower 32 to be guided into the fifth-group cam groove, by which fifth-group unit 30 moves forward in the optical-axis direction.

Cam frame 40 has helicoid groove 41, third-group cam groove 42, second-group cam groove 43, a fifth-group cam groove and a driven gear (both of which are not shown) on the inner periphery. On the outer periphery of cam frame 40, first-group cam groove 44 is disposed. Helicoid groove 41 is disposed at the front end on the front side of the inner periphery so as to be helically formed. Helicoid groove 41 engages with helicoid protrusion 72. Rotation of cam frame 40 allows helicoid protrusion 72 to be guided into helicoid groove 41, by which middle frame 70 moves toward the optical-axis direction while rotating on optical axis AX. Second-group cam groove 43 is formed at the front end on the front side of the inner periphery so as to be intersected by helicoid groove 41. Second-group cam groove 43 engages with second-group cam follower 81. Rotation of cam frame 40 allows second-group cam follower 81 to be guided into second-group cam groove 43, by which second-group unit 80 moves forward in the optical-axis direction. Third-group cam groove 42 is formed in the proximity of the center of the inner periphery in the optical-axis direction. Third-group cam groove 42 engages with third-group cam follower 62. Rotation of cam frame 40 allows third-group cam follower 62 to be guided into third-group cam groove 42, by which third-group unit 60 moves forward in the optical-axis direction. The fifth-group cam groove is formed on the back end of cam frame 40. Rotation of cam frame 40 allows fifth-group cam follower 32 to be guided into the fifth-group cam groove, by which fifth-group unit 30 moves forward in the optical-axis direction. The driven gear is formed on the back side of the inner periphery so as to extend to the back end. The driven gear engages with drive gear 22 of zoom motor unit 21. Drive gear 22 rotated by zoom motor 23 allows the entire of cam frame 40 to have rotational drive. First-group cam groove 44 is formed on the outer periphery so as to extend from the front end to the proximity of the back end. First-group cam groove 44 engages with a first-group cam follower (not shown). Rotation of cam frame 40 allows the first-group cam follower to be guided into first-group cam groove 44, by which first-group unit 90 moves forward in the optical-axis direction.

Fourth-group unit 50 retains a lens that controls focusing. For focus control, focus motor unit 51 moves fourth-group unit 50 forward in the optical-axis direction. Focus motor unit 51 has a lead screw and a focus motor for rotationally driving the lead screw. The lead screw is directly connected to the motor shaft of the focus motor. Fourth-group unit 50 has a rack that engages with the lead screw. Rotationally driven lead screw moves fourth-group unit 50 toward the optical-axis direction.

Third-group unit 60 has third-group frame 61. On the outer periphery of third-group frame 61, third-group cam follower 62 is disposed so as to protrude from third-group frame 61 toward the radial direction. Third-group cam follower 62 is inserted into third-group/fifth-group rectilinear groove 71 of middle frame 70 and engaged in third-group cam groove 42 of cam frame 40. Rotation of cam frame 40 allows third-group cam follower 62 to be guided into third-group cam groove 42, by which third-group unit 60 moves forward in the optical-axis direction.

Middle frame 70, which has a substantially cylindrical shape, retains focus motor unit 51 for driving fourth-group unit 50 on the back side of the outer periphery. Middle frame 70 has a flange at the front end, which is vertically disposed in the outer radial direction. On the flange, a rectilinear protrusion is vertically formed in the outer radial direction. The rectilinear protrusion engages in a rectilinear groove formed in the inner periphery of first-group unit 90, guiding first-group unit 90 to move forward. Middle frame 70 has helicoid protrusion 72 of a helical shape, which is disposed on the outer periphery; specifically, disposed between the back side of the flange and the front side of focus motor unit 51. Helicoid protrusion 72 engages in helicoid groove 41 of cam frame 40. Middle frame 70 has third-group/fifth-group rectilinear groove 71 and second-group rectilinear groove 73, which pass through between the inner periphery and the outer periphery. Third-group/fifth-group rectilinear groove 71 extends from the back side of helicoid protrusion 72 to the back end of middle frame 70. Third-group cam follower 62 and fifth-group cam follower 32 engage in third-group/fifth-group rectilinear groove 71. Rotation of cam frame 40 guides third-group unit 60 and fifth-group unit 30 to move forward. Second-group rectilinear groove 73 extends further behind helicoid protrusion 72 from the front end. Second-group cam follower 81 engages in second-group rectilinear groove 73. Rotation of cam frame 40 guides second-group unit 80 to move forward.

Second-group unit 80 has a substantially cylindrical shape, and a zoom lens is fixed to the front end of it. Second-group unit 80 has second-group cam follower 81 on the outer periphery. Second-group cam follower 81 is inserted into second-group rectilinear groove 73 and engages with second-group cam groove 43. Rotation of cam frame 40 allows second-group cam follower 81 to be guided to second-group cam groove 43, by which second-group unit 80 moves forward.

First-group unit 90 has a substantially cylindrical shape, and a zoom lens is fixed to the front end of it. First-group unit 90 has a rectilinear groove and a first-group cam follower on the inner periphery. First-group unit 90 is guided by a rectilinear protrusion formed in the flange of middle frame 70 so as to move forward. Besides, the first-group cam follower engages in first-group cam groove 44 of cam frame 40. Rotation of cam frame 40 allows the first-group cam follower to be guided to first-group cam groove 44, by which first-group unit 90 moves forward in the optical-axis direction.

As described above, rotating cam frame 40 with a predetermined angle moves first-group unit 90, second-group unit 80, third-group unit 60, and fifth-group unit 30 to a predetermined position, allowing lens barrel 100 to perform zooming. Besides, focus motor unit 51 drives fourth-group unit 50 so as to move forward to a predetermined position, allowing lens barrel 100 to perform focus control.

### [2. Detailed Structure of Third-Group Unit]

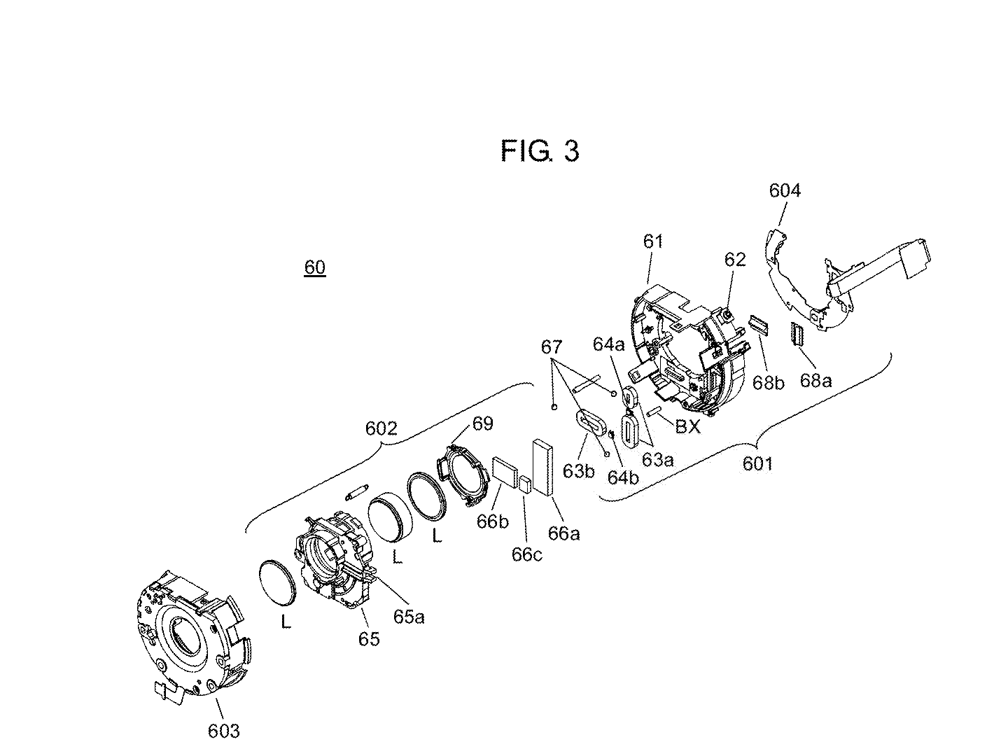

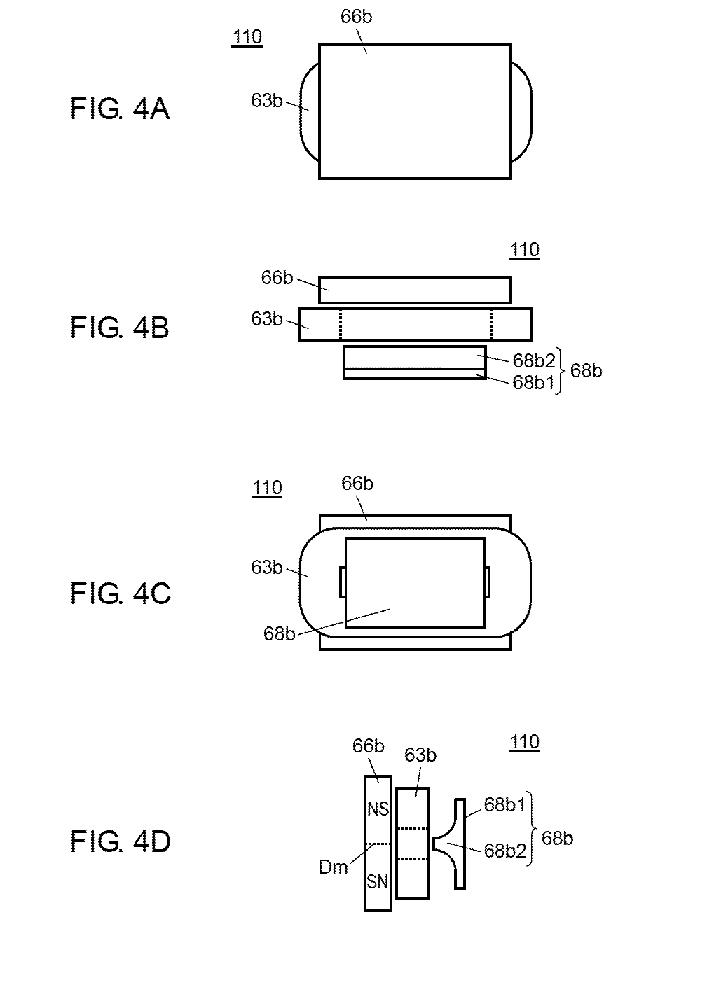

Hereinafter, the image blur correction device of the exemplary embodiment of the present disclosure will be described with reference to FIG. 3 and FIG. 4.

FIG. 3 is an exploded perspective view of third-group unit 60 in accordance with the embodiment. As shown in FIG. 3, third-group unit 60 has base 601, movable section 602, and shutter 603.

Base 601 has third-group frame 61 to which the following components are fixed: x-drive coil 63a, y-drive coil 63b, x-sensor 64a, y-sensor 64b, rotary shaft BX, x-yoke 68a, y-yoke 68b, and flexible printed board 604. In the structure above, x-drive coil 63a and y-drive coil 63b are the members for moving image blur correction lens L, while x-sensor 64a and y-sensor 64b are the members for detecting the position of image blur correction lens L. Rotary shaft BX is the member for guiding the movement of image blur correction lens L. As described earlier, third-group cam follower 62 is formed on third-group frame 61, and in the zooming operation, third-group frame 61 moves forward and backward in the optical-axis direction.

Movable member 602 has image blur correction lens frame 65 to which the following components are fixed: a plurality of image blur correction lenses L, x magnet 66a, y-drive magnet 66b, y-sensor magnet 66c, and light-shielding cap 69. Image blur correction lens L may be of one lens.

Image blur correction lens frame 65 is retained by three ceramic balls 67 in the direction of optical axis AX with respect to third-group frame 61, that is, image blur correction lens frame 65 is retained so as to be movable in a plane perpendicular to optical axis AX. At the same time, rotary shaft BX is inserted in slit 65a of image blur correction lens frame 65, so that image blur correction lens frame 65 is retained so as to be rotatable on rotary shaft BX and so as to be movable in a direction vertical to rotary shaft BX.

In the structure above, x-magnet 66a opposes x-drive coil 63a of base 601. When current is applied to x-drive coil 63a, x-magnet 66a generates thrust force in the x direction for moving image blur correction lens L. Besides, x-magnet 66a also opposes x-sensor 64a of base 601. The position of image blur correction lens L is detected by detecting changes in density o magnetic flux by x-sensor 64a.

Similarly, y-drive magnet 66b opposes y-drive coil 63b on the base side. When current is applied to y-drive coil 63b, y-drive magnet 66b generates thrust force in the y direction for moving image blur correction lens L. Besides, y-sensor magnet 66c opposes y-sensor 64b on the base side. The position of image blur correction lens L is detected by detecting changes in density of magnetic flux by y-sensor 64b.

In base 601, x-yoke 68a is made of ferromagnetic material and bonded to a position that opposes x-magnet 66a of third-group frame 61. Similarly, y-yoke 68b is made of ferromagnetic material and bonded to a position that opposes y-drive magnet 66b of third-group frame 61.

Light-shielding cap 69 is fixed to image blur correction lens frame 65. It shields against unnecessary light in the outer periphery of image blur correction lens L and suppresses generation of flare and ghost.

Image blur correction lens frame 65 is an example of a movable member. Third-group frame 61 is an example of a base member. Magnet 66, x-magnet 66a, and y-drive magnet 66b are examples of a magnet, and yoke 68, x-yoke 68a, and y-yoke 68b are examples of a yoke.

Hereinafter, the structure of the actuator will be described in detail with reference to FIG. 4A through FIG. 4D. FIG. 4A through FIG. 4D show actuator 110 (on the y side) of the exemplary embodiment. Actuator 110 (on the y side) is composed of y-drive magnet 66b, y-drive coil 63b, and y-yoke 68b. In y-drive magnet 66b, as shown in FIG. 4D, the side opposing y-drive coil 63b is magnetized to N and S poles with polarization line Dm (position where magnetic pole changes between N and S poles) as the boundary therebetween. That is, the surface opposing y-drive coil 63b of y-drive magnet 66b is magnetized in multi-polarity. On the side opposite to y-drive magnet 66b via y-drive coil 63b, y-yoke 68b is disposed. The projected area onto a plane perpendicular to optical axis AX of y-yoke 68b is smaller than that of y-drive magnet 66b. Y-yoke 68b has square (rectangular, in the description) flat section 68b1 and protrusion 68b2 formed on flat section 68b1. Protrusion 68b2 is formed in the middle of the oppositely disposed two sides (the two longer sides, in the description) of flat section 68b1 so as to be parallel to the two sides. That is, protrusion 68b2 is formed in the middle part of flat section 68b1. The cross-section of protrusion 68b2 (in the description, the cross-section that is cut by a plane perpendicular to the two longer sides) has a rectangular or a trapezoidal shape. In FIG. 4, the oppositely disposed two sides of protrusion 68b2 are shaped into an arc. Actuator 110 is so formed that protrusion 68b2 of y-yoke 68b is placed to a position corresponding to polarization line Dm of y-drive magnet 66b. Actuator 110 may be formed into a structure where protrusion 68b2 of y-yoke 68b is placed to a position that opposes the boundary area of two poles of y-drive magnet 66b (i.e., the area adjacent to polarization line Dm) or close to the boundary area.

The actuator disposed on the x side is formed of x-magnet 66a, x-drive coil 63a, and x-yoke 68a. Although the actuator on the x side is not shown, x-yoke 68a has a structure the same as that of y-yoke 68b, and x-magnet 66a has a structure the same as that of y-drive magnet 66b. Besides, the positional relation of x-yoke 68a and x-magnet 66a is the same as that of y-yoke 68b and y-drive magnet 66b. The projected area onto a plane perpendicular to optical axis AX of x-yoke 68a is smaller than that of x-magnet 66a. Having a flat section and a protrusion, x-yoke 68a has a shape similar to that of y-yoke 68b. The actuator on the x side is so formed that the protrusion of x-yoke 68a is placed to a position corresponding to the polarization line of x-magnet 66a.

As described above, forming a protrusion on y-yoke 68b decreases changes in magnetic attractive force (hereinafter referred to as thrust attractive force) between y-drive magnet 66b and y-yoke 68b exerted in the optical-axis direction. At the same time, the structure decreases magnetic attractive force (hereinafter referred to as cogging force) exerted in a direction perpendicular to optical axis AX. This is also true for the protrusion formed on x-yoke 68a.

Change in thrust attractive force causes generation of a force, which deforms image blur correction lens frame 65 with movement of movable section 602. Such force may cause image blur correction lens frame 65 to vibrate easily.

Besides, cogging force often works in a direction opposite to the thrust force generated by the drive coil. With an insufficient amount of the thrust force of the drive coil, movable member 602 cannot be driven; even if it can be driven, positional accuracy of image blur correction lens L becomes worse, which can degrade the performance of the image blur correction device.

Therefore, it is commonly preferable that changes in thrust attractive force should be small as possible, and cogging force should be small.

Next, relation between the shape of the yoke and the aforementioned forces (i.e., the thrust attractive force and the cogging force) will be described.

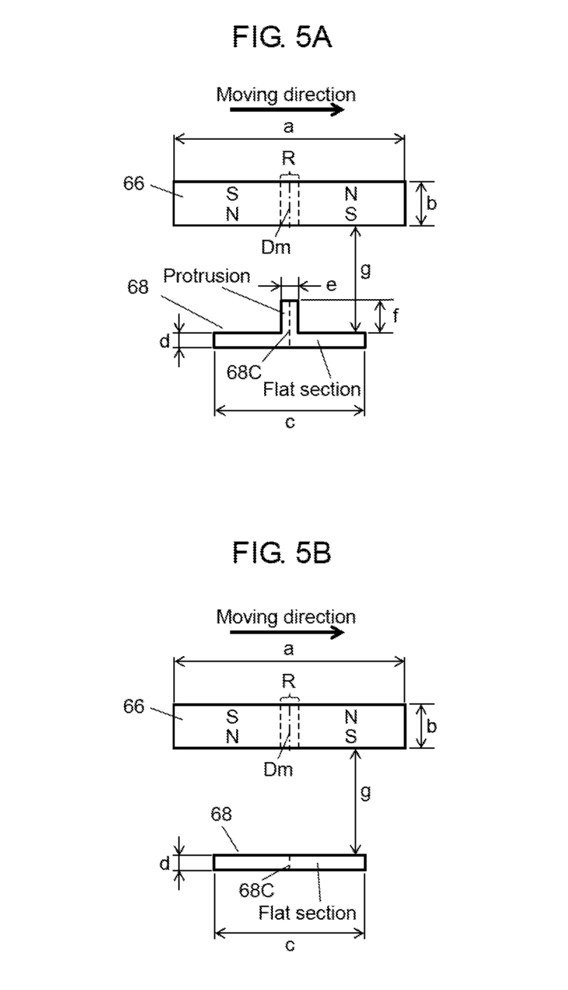

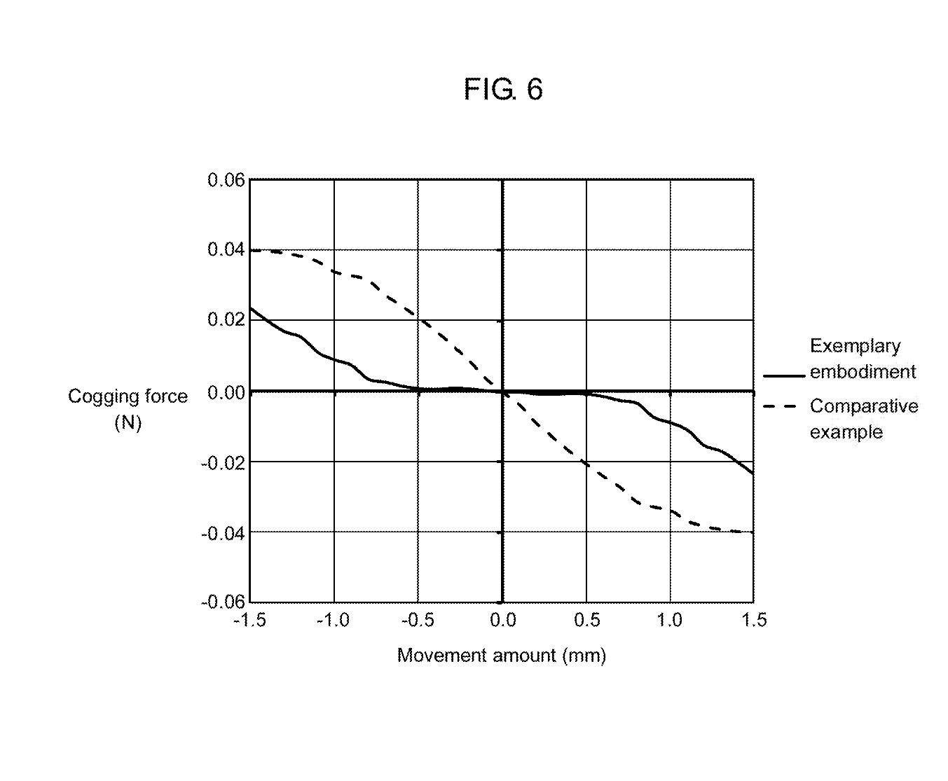

FIG. 5A illustrates a positional relation between yoke 68 and magnet 66 as an example of the exemplary embodiment. FIG. 5B illustrates a positional relation between yoke 68 and magnet 66 of a comparative example.

In FIG. 5A, magnet 66 is magnetized to N and S poles, having polarization line Dm as the boundary of polarity. Region R, which is close to polarization line Dm, is a substantially non-magnetized, or has magnetism weaker than the peripheral region. That is, region R is the position at which the polarity of magnet 66 changes. Yoke 68 has a flat section and a protrusion. Yoke 68 and magnet 66 are disposed so that the protrusion of yoke 68 is located at a position opposing region R of magnet 66 or in proximity to the position. ‘The protrusion is located in proximity to the position opposing region R’ means that the protrusion is located within a position where the protrusion has moved a distance equal to its width away from the position where the protrusion becomes outside the region R. For example, suppose that the protrusion has width ‘e’ of 0.5 mm and region R has a width of 0.5 mm, then ‘the protrusion is located in proximity to the position opposing region R’ means that the distance between polarization line Dm and center line 68c measures 1 mm or less. Center line 68c of yoke 68 is shown by broken lines in FIG. 5A and FIG. 5B. The structure of the comparative example of FIG. 5B differs from the structure of FIG. 5A in that yoke 68 is formed into a flat shape with no protrusion.

FIG. 6 shows relation between a movement amount of magnet 66 when it moves in the moving direction (represented by the arrow) and cogging force applied to the moving magnet in each structure shown in FIG. 5A and FIG. 5B. In FIG. 6, the horizontal axis of the graph represents a movement amount of magnet 66, and the vertical axis represents the cogging force exerted in a direction parallel to the moving direction of magnet 66. In FIG. 5A and FIG. 5B, when polarization line Dm of magnet 66 coincides with the position of center line 68c of yoke 68, magnet 66 has a movement amount of 0 (zero). With reference to the position of movement ‘0’, when magnet 66 moves in the moving direction (shown by the arrow) in FIG. 5A and FIG. 5B, magnet 66 has a positive amount of movement; while magnet 66 move in the opposite direction, it has a negative amount of movement. Similarly, when the cogging force, which is applied to magnet 66, exerts in the direction the same as the moving direction of magnet 66 shown in FIG. 5A and FIG. 5B, it is defined as a positive cogging force; while when the force exerts in the direction opposite to the moving direction of magnet 66, it is defined as a negative cogging force.

The cogging force shown in FIG. 6 is calculated by magnetic field analysis using a computer based on a design example. The dimensions of the design example will be described below with reference to FIG. 5A and FIG. 5B. As for magnet 66, width ‘a’ measures 6.4 mm; thickness ‘b’ measures 1.2 mm; the depth (i.e. the length in a direction vertical to the drawing) measures 9.1 mm. As for yoke 68, width ‘c’ of the flat section measures 4.2 mm; thickness ‘d’ of the flat section measures 0.4 mm; width ‘e’ of the protrusion measures 0.5 mm; height ‘f’ of the protrusion measures 1.05 mm; and the depth (i.e. the length in a direction vertical to the drawing) measures 6.5 mm. Distance ‘g’ between the flat section of yoke 68 and magnet 66 measures 3.05 mm.

In the example of the embodiment (indicated by the solid line) of FIG. 6, almost no cogging force is generated within the range from −0.5 mm to +0.5 mm of the movement amount. In contrast, in the comparative example (indicated by the broken line), the cogging force largely changes in the periphery of the position of movement ‘0’. Specifically, when magnet 66 has a positive amount of movement, negative cogging force is generated, while when magnet 66 has a negative amount of movement, positive cogging force is generated. That is, the cogging force works in the direction in which magnet 66 is moved back to the position of movement ‘0’.

In the comparative example, when the magnet moves by 0.5 mm, cogging force of 0.02 N exerts on the magnet. This means that another force of 0.02 N is necessary in addition to a usually set load (e.g. the inertial load of image blur correction lens L). As a result, the structure of the comparative example needs an actuator larger in size than that of the embodiment example.

In contrast, according to the embodiment example, almost no cogging force is generated in the movement range from −0.5 mm to +0.5 mm. This allows the structure to employ an actuator having a size enough for driving the usually set load. That is, compared to the comparative example, the actuator of the example of the embodiment has decrease in size.

The movement amount with the aforementioned range (from −0.5 mm to +0.5 mm) is a preferable stroke for the image blur correction device. Decrease in size of the actuator means decrease in size of the image blur correction device; and accordingly, decrease in size of the lens barrel containing the image blur correction device.

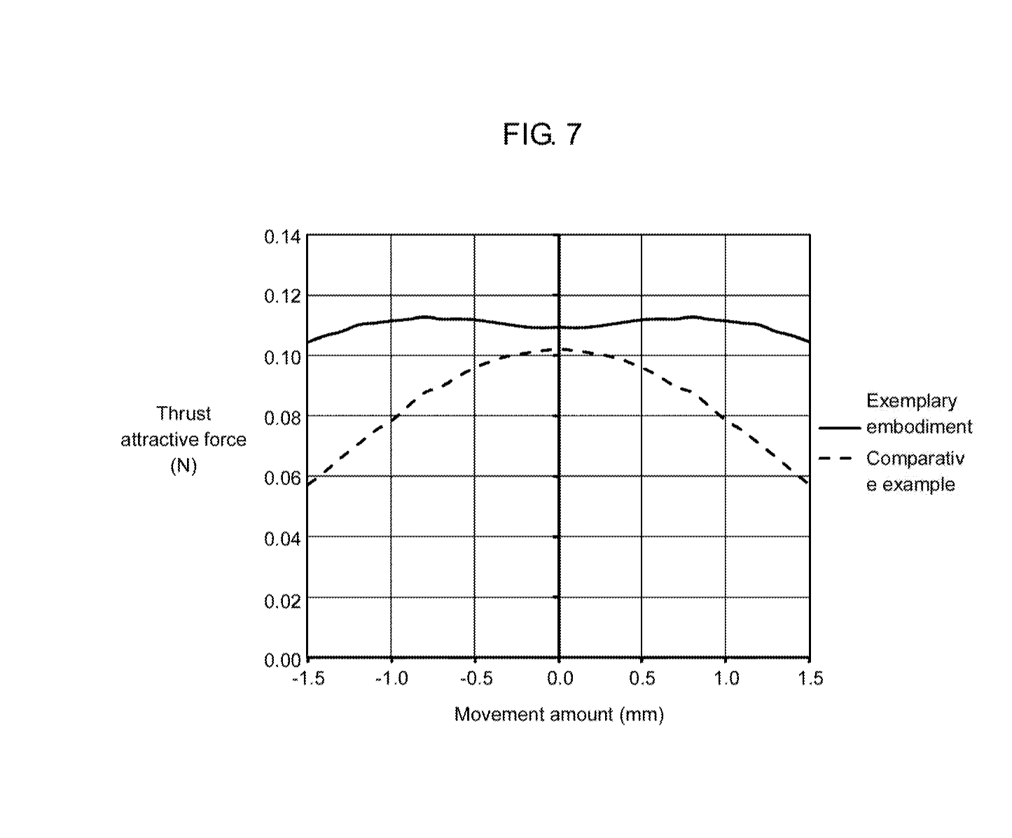

FIG. 7 shows relation between a movement amount of magnet 66 and thrust attractive force exerted on magnet 66 when magnet 66 moves in the moving direction (indicated by the arrow) shown in FIG. 5A and FIG. 5B.

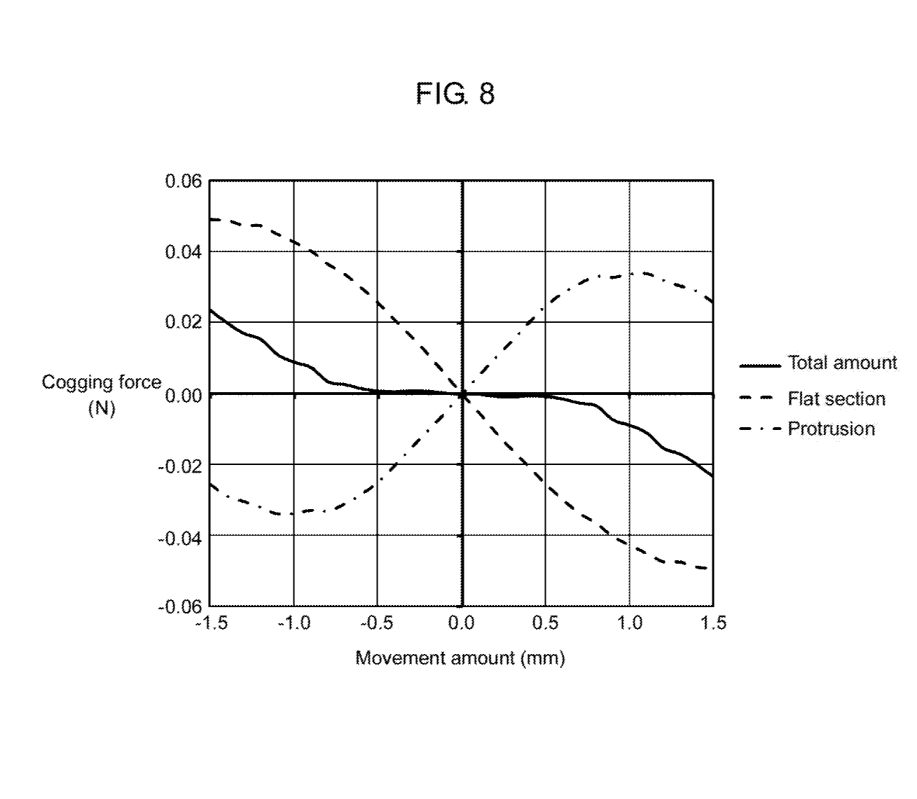

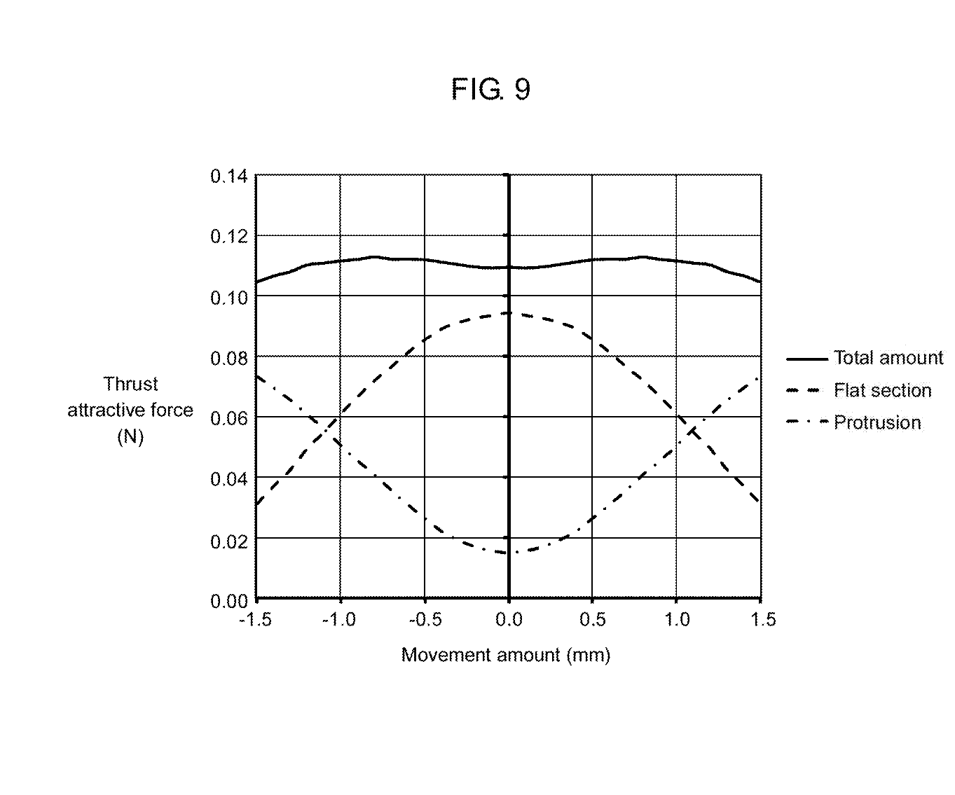

In FIG. 7, the horizontal axis of the graph represents a movement amount of magnet 66 and the vertical axis represents thrust attractive force. In FIG. 7 and also in FIGS. 8 and 9, definitions relating to the movement amount of magnet 66 (i.e., the position of movement ‘0’, positive and negative amount of movement) are the same as those in FIG. 6. When the thrust attractive force, which is applied to magnet 66, exerts in the positive direction on the z axis, it is defined as a positive thrust attractive force.

The thrust attractive force shown in FIG. 7 is calculated, together with the cogging force shown in FIG. 6, by magnetic field analysis using a computer.

According to the structure of the embodiment, as shown in FIG. 7, the thrust attractive force is kept at around 0.11N and does not change so much. In contrast, the thrust attractive force measured in the comparative example reaches the maximum at the position of movement ‘0’ and it decreases in the both of the positive and the negative sides in the x-axis direction.

When the structure of the exemplary embodiment is employed for an image blur correction device, the thrust attractive force has to have a certain amount or greater for preventing the movable member containing image blur correction lens L from vibration in the direction of optical axis AX.

Further, changes in thrust attractive force has an unwanted effect on image blur correction lens frame 65 such as deformation, causing vibration of it, for example.

Unlike in the comparative example, in the structure of the exemplary embodiment, since the thrust attractive force has little change, it is no need for increasing the thrust attractive force, which hardly causes vibration of image blur correction lens frame 65.

Hereinafter, how the yoke shape of the embodiment is effective in decreasing cogging force and having less change in thrust attractive force will be described with reference to FIG. 8 and FIG. 9.

FIG. 8 illustrates a principle of reduction of cogging force. In the graph of FIG. 8, the broken line represents the cogging force produced by the flat section of yoke 68, and the dashed line represents the cogging force produced by the protrusion of yoke 68. The solid line represents the sum of the cogging force shown by the broken line and the cogging force shown by the dashed line, i.e., it represents the total amount of the cogging force produced by yoke 68.

The cogging force produced by the flat section of yoke 68 (represented by the broken line in FIG. 8) has a changing pattern nearly the same as that observed in the comparative example shown in FIG. 6. This is because that the flat section opposes across the two poles of N and S; therefore, the flux passing through the flat section decreases with no regard to the moving direction of magnet 66. On the other hand, the cogging force produced by the protrusion of yoke 68 has the sign opposite to that produced by the flat section. This is because that the protrusion of yoke 68 opposes a weakly magnetized part of magnet 66 in the periphery of polarization line Dm, and therefore the protrusion produces force attracted toward the N pole or the S pole of magnet 66.

Considering above, when the distance between magnet 66 and yoke 68, the width of the flat section, and the height of the protrusion are properly determined, the preferable state—in which the cogging force is hardly generated within a predetermined movable range—is obtained, as shown in the graph.

FIG. 9 illustrates a principle of reduction of the amount of change in thrust attractive force. In the graph of FIG. 9, the broken line represents the thrust attractive force produced by the flat section of yoke 68, and the dashed line represents the thrust attractive force produced by the protrusion of yoke 68.

The thrust attractive force produced by the flat section of yoke 68 (represented by the broken line in FIG. 9) has a changing pattern similar to that of the comparative example shown in FIG. 7. Specifically, the thrust attractive force reaches the maximum when magnet 66 has a movement amount of ‘0’ and it decreases with the movement of magnet 66 in the both sides. This is because that the flat section opposes across the two poles of N and S; therefore, the flux passing through the flat section decreases with no regard to the moving direction of magnet 66. In contrast, the thrust attractive force produced by the protrusion of yoke 68 decreases to the minimum at around the position of movement ‘0’, and it increases toward the positive and the negative direction of the movement of magnet 66. This is because that the protrusion of yoke 68 opposes a weakly magnetized part (region R) of magnet 66 in the periphery of polarization line Dm; therefore, the flux increases with the yoke becomes close to the N pole or the S pole, increasing the thrust attractive force.

Considering above, when the distance between magnet 66 and yoke 68, the width of the flat section, and the height of the protrusion are properly determined, the preferable state—in which the amount of change in the thrust attractive force is kept small within a predetermined movable range—is obtained, as shown in the graph.

As described above, forming yoke 68 into an appropriate shape allows an actuator to have decrease in cogging force and in changing amount of thrust attractive force in the relative movement of magnet 66 and yoke 68.

The structure described above is the example where the cogging force is next to zero within a predetermined movement range, but it is not limited to; for example, the actuator may be formed so as to intentionally keep a constant amount of cogging force by differently determining the distance between magnet 66 and yoke 68, the width of the flat section, and the height of the protrusion. Such a controlled amount of cogging force generates force that works toward the central direction, allowing the actuator to be easily kept at the center position. Further, locating the protrusion of yoke 68 to a position slightly shifted from polarization line Dm of magnet 66 allows the actuator to intentionally generate the cogging force always in one direction at the center position.

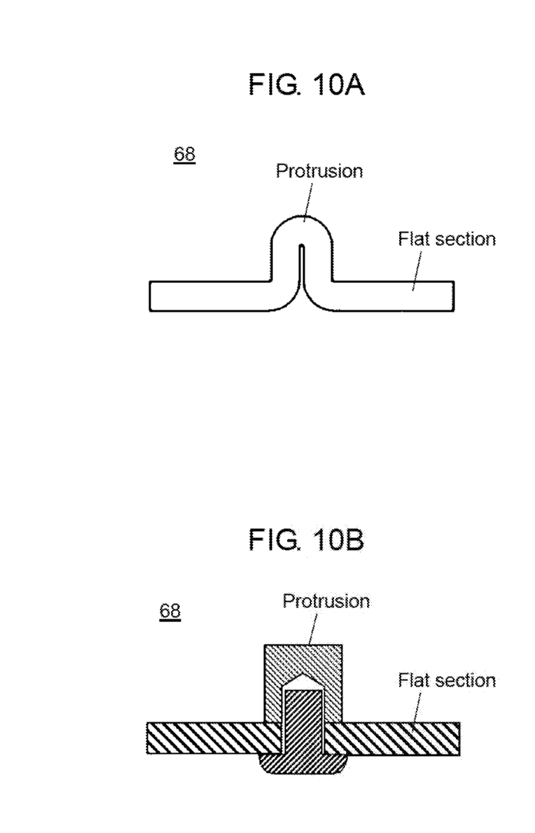

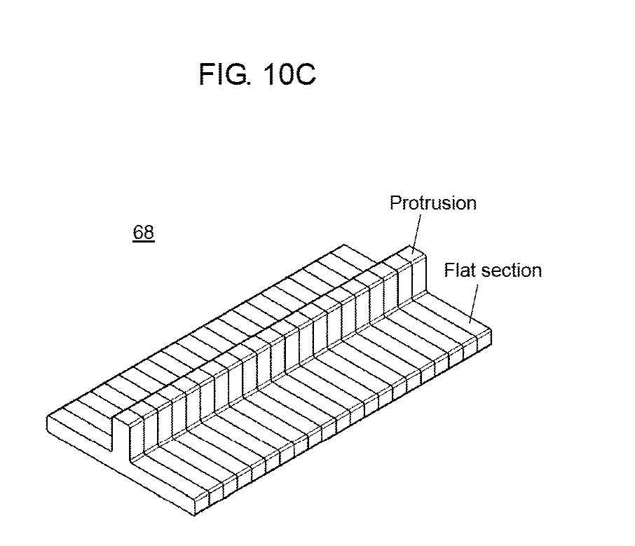

Next, the method of manufacturing yoke 68 will be described with reference to FIG. 10A through FIG. 10C. FIG. 10A shows an example of yoke 68 whose protrusion is formed by bending a wood plate. FIG. 10B shows another example of yoke 68 where the flat section and the protrusion are separately manufactured and then fixed them with a screw. FIG. 10C shows another example of yoke 68 having a stacked structure of a plurality of cut-out plate materials of a T-shape.

The structure of the embodiment has been described in detail as an example of the technology of the present disclosure with reference to accompanying drawings.

In addition to a component essential for solving problems, the accompanying drawings and the in-detail description can contain a component used for illustrative purpose in the technology but not essential for solving problems. It will be understood that not all the components described in the drawings and description are essential for solving problems.

Further, it will be understood that the aforementioned embodiment is merely an example of the technique of the present disclosure. That is, the technique of the present disclosure is not limited to the structure described above, allowing modification, replacement, addition, and omission without departing from the spirit and scope of the claimed disclosure.

What is claimed is:

1. An actuator comprising:
a magnet; and
a yoke that generates attractive force between the yoke and the magnet,
wherein, at least any one of the magnet and the yoke is movable relative to an other in a plane perpendicular to a direction of magnetization of the magnet, and
the yoke has a flat section and a protrusion protruding from the flat section toward a direction of the magnet, and the protrusion is disposed in a middle part of the flat section.

2. The actuator of claim 1, wherein the protrusion is disposed on a position that opposes a region at which a polarity of the magnet changes or is disposed in proximity to the position.

3. A lens barrel comprising:
an image blur correction device comprising:
a base member;
a movable member to which a lens is fixed;
a magnet; and
a yoke that generates attractive force between the yoke and the magnet,
wherein, at least any one of the magnet and the yoke is movable relative to an other in a plane perpendicular to a direction of magnetization of the magnet,
the yoke has a flat section and a protrusion protruding toward a direction of the magnet, and the protrusion is disposed in a middle part of the flat section, and
any one of the magnet and the yoke is disposed on the movable member and an other is disposed on the base member.

4. The lens barrel of claim 3, wherein the protrusion is disposed on a position that opposes a region at which a polarity of the magnet changes or is disposed in proximity to the position.
